(19) United States
(12) Patent Application Publication
(10) Pub. No.: US 2007/0095649 A1
(43) Pub. Date: May 3, 2007

(54) Ambient ozone control system

(75) Inventor: Robert E. Barlow, Johnson City, TN (US)

Correspondence Address: PITTS AND BRITTIAN P C, P O BOX 51295, KNOXVILLE, TN, 37950-1295, US

(73) Assignee: Alpine Technologies, Inc., Greeneville, TN (US)

(21) Appl. No.: 11/259,998

(22) Filed: Oct. 27, 2005

(51) Int. Cl. C01B 13/10; B01J 19/08

(52) U.S. Cl. 204/176; 422/186.07

(57) ABSTRACT

An ambient ozone control system for generating a desired ozone concentration within a substantially enclosed single-room structure. The system is provided for estimating the volume of the structure in which it is being utilized, and for generating a desired output level of ozone based upon the calculated structure volume. The system includes a user interface, which includes an ozone concentration control for adjusting the desired ozone concentration, a fan control for adjusting the intensity of a fan, and a display. A structure measuring device acquires at least one interior dimension of the structure by measuring the distance from the structure measuring device to at least one of the boundaries of the structure. The processing device calculates the amount of ozone required to achieve the desired ozone concentration within the structure and causes the ozone generating device to generate that amount of ozone.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to a system for introducing ozone to the ambient environment. More particularly, this invention pertains to a system for generating a desired ozone concentration within a substantially enclosed single-room structure.

2. Description of the Related Art

The current state of technology has created a desire, and sometimes a need, to purify air. It is known that many noxious gases make their way into homes, offices, and other enclosed structures. Additionally, humidity, germs, dust, and odors create the need to purify the air within enclosed structures. An effective solution for purifying air within an enclosed structure that contains the aforementioned impurities is to introduce ozone to the air within the enclosed structure. There are many conventional devices that generate and distribute ozone within an enclosed structure. However, the distribution of too much ozone has adverse consequences. Adverse effects associated with over-oxidation of an enclosed structure are well-known and include oxidation damage to various materials, such as rubber, and heath problems to humans.

There are several conventional devices for generating, distributing, and regulating ozone within an enclosed structure. One type of conventional device includes a meter for measuring the concentration of ozone. Additionally, these conventional devices include an ozone-diluting feature, such as a filter or an ozone decomposing vapor. These conventional devices operate by first distributing ozone within the enclosed structure. When the ozone meter detects an ozone concentration above the desired ozone concentration, the device employs the ozone-diluting feature. These devices are limited by circumstances that require the ozone concentration level to not exceed the desired ozone concentration. Additionally, by the time the ozone-diluting feature returns the ozone concentration to the desired ozone concentration, oxidation damage could have already occurred. Also, conventional devices such as these are relatively complicated systems in that they require an ozone meter, an ozone-diluting feature, and sometimes professional installation. Additionally, conventional devices such as these can be permanent installments in the user's home or office.

Other conventional devices are less complicated in that they include only ozone generators and distributors and not ozone meters and ozone-diluting features. These conventional devices are typically easily installed and do not become permanent fixtures within a home or office. However, these conventional devices require the user to manually acquire the dimensions of the structure, such as a room, that the conventional device is to oxidize. After the dimensions of the structure are acquired, the conventional device calculates the volume of the room and distributes the amount of ozone that achieves the desired ozone concentration. Manually acquiring the dimensions of a room can be inconvenient, difficult, or unfeasible considering the condition of the user and the contents and layout of the structure. Consequently, while relatively uncomplicated, this type of conventional device is limited in that it cannot automatically acquire the dimensions of the structure for which it is to oxidize such that the desired ozone concentration within the structure is achieved.

Typical of the art are those devices disclosed in the following U.S. patents:

| Patent No. | Inventor(s) | Issue Date |
|---|---|---|
| 5,316,741 | P. B. Sewell et al. | May 31, 1994 |
| 5,514,345 | C. D. Garbutt et al. | May 7, 1996 |
| 5,788,930 | L. D. McMurray | Aug. 4, 1998 |
| 5,923,037 | R. Stager et al. | Jul. 13, 1999 |
| 5,924,597 | D. M. Lynn | Jul. 20, 1999 |
| 5,961,919 | H. Tachibana et al. | Oct. 5, 1999 |
| 6,066,348 | J. T. C. Yaun et al. | May 23, 2000 |
| 6,110,431 | O. K. Dunder | Aug. 29, 2000 |
| 6,153,151 | D. A. Moxley et al. | Nov. 28, 2000 |
| 6,156,268 | M. R. Curry et al. | Dec. 5, 2000 |
| 6,276,304 | P. L. Tai | Aug. 21, 2001 |
| 6,312,606 | W. E. Conrad | Nov. 6, 2001 |
| 6,503,547 | C. Lima | Jan. 7, 2003 |
| 6,810,832 | J. Ford | Nov. 2, 2004 |

Of these patents, the '741 patent issued to Sewell et al., discloses an ozone generator for the treatment of small volumes of room air for the removal of odors. If the volume of air to be treated is known, then the output in mg/hr necessary to produce ozone backgrounds of 0.04 ppm and below can be readily computed. Such concentrations are comparable to the natural background and generally acceptable for continuous human occupation.

Garbutt et al., in their '345 patent, disclose an apparatus for disinfecting an enclosed space for the preservation and sterilization of harvested foods, and for reducing toxic gas levels associated with confining animals in an enclosed space using ozone and an ozone distribution device.

In the '930 issued to McMurray, an apparatus is disclosed for deodorizing and purifying an enclosure such as a building structure or vehicle using an ozone generator. The '930 apparatus is controlled with an electronic logic circuitry and sensors which automatically regulate ozone exposures to peak at an antiseptic level. One embodiment of the apparatus uses an ozone decomposing material to eliminate the harmful residual ozone concentration within the enclosure which is present immediately after an effective ozone treatment. Another embodiment allows for control of the apparatus from outside the enclosure being purified, allowing the operator to alter the outcome of the treatment

Stäger et al., in their '037 patent, disclose a device for determining the ozone concentration by utilizing the surface chemiluminescence effect. The '037 device includes a fan, a chemiluminescence element, a photomultiplier, a temperature sensor, and control electronics. An airflow generated by the fan passes via a suction pipe and an adjoining light trap system through a venturi-shaped channel structure along a metal block in which the temperature sensor is housed. The device is calibrated with respect to the temperature dependence of the reaction of a chemiluminescence disc attached to the bottom of the metal block by determining the output voltage of the photomultiplier in dependence on the temperature at a predetermined ozone concentration in the measured air. Also integrated into the metal block is a light-emitting diode which is switched in a predetermined switching cycle as a reference light intensity and sends a light to the photomultiplier via an opening in the metal block, thus periodically overriding the actual ozone measurement process and resulting in a periodic calibration of the temperature dependence of the output voltage of the photomultiplier.

Lynn, in his '597 patent, discloses a fragrance dispensing apparatus and method for use in a multi-room building having an existing HVAC system ventilated by a forcing fan. The apparatus includes a plurality of fragrance containers mounted in communication with the HVAC ductwork leading into a given room. Each fragrance container is controlled by a separate solenoid, which is in turn controlled by a separate programmable timer. All of the programmable timers are connected to a single fan timer, which controls the operation of the forcing fan. The method allows one or more of the programmable timers to activate corresponding containers to dispense fragrances as the forcing fan runs to distribute the fragrances into the rooms supplied by the ductwork

In their '919 patent, Tachibana et al., disclose a deodorizing and disinfecting apparatus having a catalyst deterioration detection function. The '919 apparatus includes an air supply portion for inhaling air inside; an ozone generating portion for discharging ozone to the inhaled air: a catalyst for accelerating deodorizing and disinfecting actions and decomposition of the ozone disposed downstream from the ozone generating portion; an ozone sensor for detecting the concentration of remaining ozone disposed downstream from the catalyst; and means for repeating a cycle including stop of ozone discharge from the ozone generating portion for a predetermined time period when the concentration of the remaining ozone reaches a predetermined concentration or more, and for determining that the catalyst is deteriorated when a condition wherein an interval between times when the concentration of the remaining ozone is not less than a predetermined concentration becomes shorter than a predetermined time period is recognized at a predetermined frequency, and then for stopping discharge of the ozone.

Yaun et al., in their '348 patent, disclose a method of disinfecting a foodstuff using a gaseous mixture containing ozone in an amount and for a time sufficient to effect disinfection.

In the '431 patent, Dunder discloses an ozone dispensing system having an ozone gas generating means, electrical means to control the concentration of ozone produced by said ozone gas generating means, means to control the concentration of ozone in a preset dispensed volume, an oxygen supply and venting means disposed between said ozone gas generating means and said dispensing of said ozone, said venting means for continuous venting of said ozone.

Moxley et al., in their '151 patent, disclose a system and method for generating ozone for use in open or closed loop process applications. The '151 device uses a fluid, such as water, as a primary process medium. A water storage tank is supplied by a water supply line for temporarily storing water for treatment and subsequent use in a process. An electromagnetic flux unit is connected to the water supply line for exposing water supplied to the tank to an electromagnetic field thereby magnetically polarizing contaminants and dissolved solids present in the water. An apparatus is provided for producing highly pure oxygen from ambient air for use as a feed gas in generating ozone. A corona discharge ozone generator produces high purity ozone from a highly pure oxygen feed gas. An impeller apparatus, including a rapidly rotating shear impeller, injects ozone created by the ozone generator into water wherein the ozone is absorbed thus yielding a substantially high level of dissolved ozone gas in a given volume of water. An apparatus is provided for measuring the concentration of dissolved ozone present in water. A microprocessor based controller controls the system to reach and maintain suitable ozone concentration levels.

Curry et al., in their '268 patent, disclose an ozone distribution system for an enclosed space defined within an enclosure having at least one vent through which gases can escape from the enclosed space. The '268 system includes a first tube having an interior and extending through at least a portion of the enclosed space. At least one diffuser is integrally connected to the first tube, having an interior in communication with the interior of the first tube, and also having a plurality of spaced outlets. A second tube having at least one outlet is positioned in the interior(s) of the diffuser(s). An ozone generator is provided for generating ozone and establishing a flow thereof through the second tube to and through the outlet(s) of the second tube such that ozone is released into the interior(s) of the diffuser(s). An air intake fan takes in air from outside the enclosed space and establishes a flow thereof through the interior of the first tube, into the interior(s) of the diffuser(s), and through the outlets of the diffuser(s) so as to carry ozone therewith for distribution in the enclosed space.

Tai, in his '304 patent, discloses a method and system for ozone injection into a confined area.

Conrad, in his '606 patent, discloses a method and apparatus for monitoring the degree of treatment of a material by a reactive fluid. The '606 invention is monitored by reacting the unreacted fluid to produce a signal such as heat, and measuring the signal so produced.

Lima teaches, in his '547 patent, a method of preserving natural perishable products by dispersing ozone throughout a substantially closed room containing the natural perishable products> The ozone is generated from the oxygen in the air inside the substantially closed room.

Finally, Ford, in his '832 patent, discloses an automated animal house for increasing the health and longevity of animals, such as poultry, and swine. The automated poultry house provides for automatic removal of contaminated bedding and replacement with fresh or recycled bedding. The automated animal house also greatly reduces concentration of dust and noxious gases to provide for a cleaner and healthier environment for the animals and workers.

### BRIEF SUMMARY OF THE INVENTION

An ambient ozone control system is disclosed for generating a desired ozone concentration within a substantially enclosed single-room structure. The ambient ozone control system includes a structure measuring device, a processing device, and an ozone generating device. The system is provided for estimating the volume of the structure in which it is being utilized, and for generating a desired output level of ozone based upon the calculated structure volume.

The system includes a user interface, which includes an ozone concentration control for adjusting the desired ozone concentration, a fan control for adjusting the intensity of a fan, and a display for displaying for example, the current settings of the system. The system also includes a remote control, which includes the same controls as the user interface. Namely, the remote control includes a power switch, an ozone concentration control, and a fan control. A user of the system communicates the desired ozone concentration and the desired fan intensity to the ambient ozone control system by manually engaging the user interface or by using the remote control.

The structure measuring device acquires at least one interior dimension of the structure by measuring the distance from the structure measuring device to the boundaries of the structure, namely the walls, the ceiling, and the floor. The structure measuring device measures the aforementioned distances using, ion one embodiment, sonar. More specifically, the structure measuring device transmits a signal and simultaneously initiates an internal counter. The transmitted sound wave reflects off the nearest object, such as a wall of the structure, and returns to the structure measuring device. When the sound wave returns to the structure measuring device, the structure measuring device receives the signal and the processing device stops the internal counter. The processor then calculates the distance between the ambient ozone generating device and a wall, ceiling, or floor.

In the simplest embodiment, the system is placed in approximate center of the structure and the assumption is made that the structure is square. Further, the assumption is made that the ceilings are disposed at a standard ceiling height such as eight feet above the floor. With these assumptions, the volume of the structure is estimated. It will be understood that measurements may be taken in more than one direction such that the volume within the structure is more accurately determined.

After the processor calculates the volume of the structure, the processing device calculates the amount of ozone required to achieve the desired ozone concentration within the structure. The processor causes the ozone generating device to generate the amount of ozone required to achieve the desired ozone concentration. Additionally, while the ozone generating device is generating ozone, the processor causes the fan to circulate the generated ozone throughout the structure such that the generated ozone within the structure is substantially evenly distributed.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of the ambient ozone control system illustrating various features of the present invention;

FIG. 2 is a block diagram illustrating the interconnection of various components of the ambient ozone control system of FIG. 1;

FIG. 3 is a perspective illustration of the ambient ozone control system of the present invention shown within a structure;

FIG. 4 is a circuit diagram illustrating various features of the ambient ozone control system of FIG. 1; and

FIG. 5 is a flow diagram illustrating the functions of the ambient ozone control system of FIG. 1.

### DETAILED DESCRIPTION OF THE INVENTION

The present invention is an ambient ozone control system for generating a desired ozone concentration within a substantially enclosed single-room structure. The ambient ozone control system of the present invention is illustrated generally at 10 in the Figures. The ambient ozone control system, or system 10, includes a structure measuring device, a processing device, and an ozone generating device. The system 10 is provided for estimating the volume of the structure in which it is being utilized, and for generating a desired output level of ozone based upon the calculated structure volume. The structure measuring device measures the distance from the structure measuring device to at least one sidewall of the substantially enclosed single-room structure. Additionally, the structure measuring device may measure the distance from the structure measuring device to the ceiling of the structure and to the floor of the structure. The processing device, which is in electrical communication with the structure measuring device, reads the measured dimensions of the structure from the structure measuring device. The processing device calculates the volume of the structure using the dimensions measured by the structure measuring device. Then, the processing device, considering the calculated volume of the structure, calculates the amount of ozone required to create the desired ozone concentration within the structure. Next, the processing device, which is in electrical communication with the ozone generating device, causes the ozone generating device to generate the amount of ozone necessary to create the desired ozone concentration within the structure.

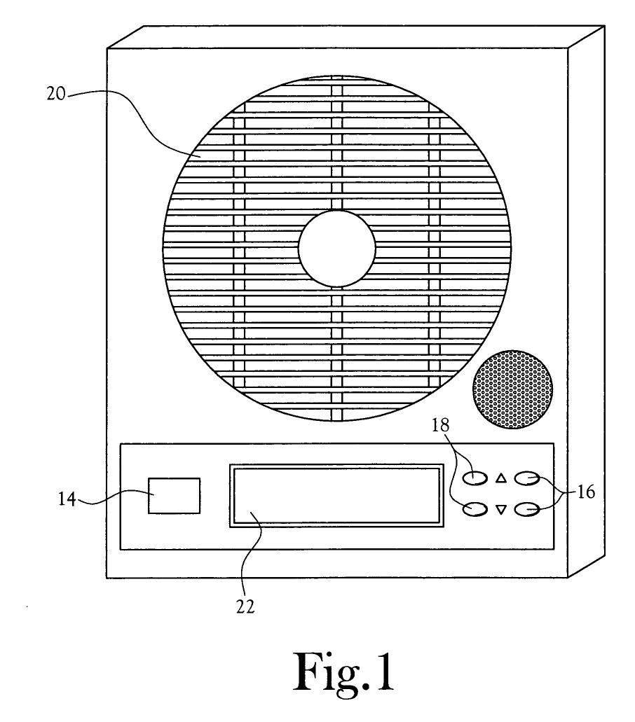

FIG. 1 illustrates a perspective view of one embodiment of the system 10 of the present invention. The system 10 includes a user interface 12, which, in the illustrated embodiment, includes a power switch 14 for turning the ambient ozone control system 10 On and Off, an ozone concentration control 16 for adjusting the desired ozone concentration, a fan control 18 for adjusting the intensity of a fan 20, and a display 22 for displaying for example, the current settings of the system 10. The system 10 of the illustrated embodiment also includes a remote control 24, which includes the same controls as the user interface 12. Namely, the remote control 24 includes a power switch 14A, an ozone concentration control 16A, and a fan control 18A. As will be discussed below in greater detail, a user of the system 10 communicates the desired ozone concentration and the desired fan 20 intensity to the ambient ozone control system 10 by manually engaging the user interface 12 or by using the remote control 24.

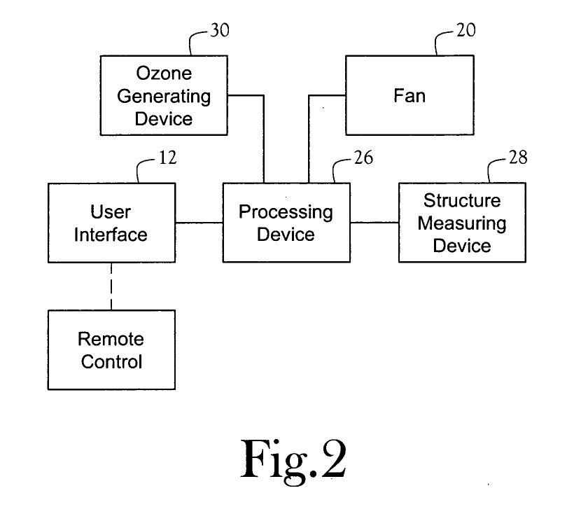

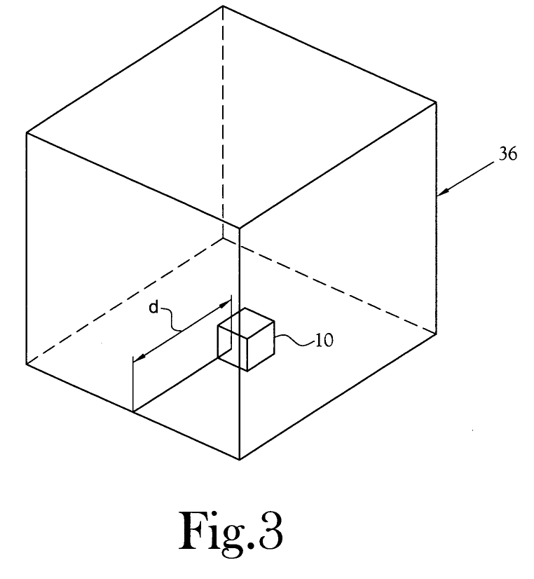

FIG. 2 is a block diagram of the system 10 illustrating the interconnection of various features of the present invention. The system 10 of the illustrated embodiment includes a processor 26 in communication with the user interface 12, the fan 20, a structure measuring device 28, and an ozone generating device 30. The processor 26 reads the desired ozone concentration and the desired intensity of the fan 20 from the user interface 12. Additionally, the processor 26 causes the structure measuring device 28 to acquire at least one interior dimension of the substantially enclosed single-room structure 36 in which the system 10 is disposed. A single-room structure 36 is, for example, a free-standing structure that is entirely open at the interior, such as a garage. A single-room structure 36 is also, for example, a room that is part of a larger building, such as an office within an office building. A substantially enclosed structure 36 also includes openings in the interior, such as, for example, doors, windows, and air vents.

As illustrated in FIG. 3, the structure measuring device 28 acquires at least one interior dimension of the structure 36 by measuring the distance from the structure measuring device 28 to the boundaries of the structure, namely the walls, the ceiling, and the floor. The structure measuring device 28, of the illustrated embodiment, measures the aforementioned distances utilizing the principle of sonar. More specifically, the structure measuring device 28 transmits a signal. When the structure measuring device 28 transmits the signal, the processing device 26 initiates an internal counter. The transmitted sound wave reflects off the nearest object, such as a wall of the structure, and returns to the structure measuring device 28. When the sound wave returns to the structure measuring device 28, the structure measuring device 28 receives the signal and the processing device 26 stops the internal counter. Where the signal is a sound wave, knowing the speed of sound (1100 ft/s) and the sound wave's time of travel as derived from the internal counter, the processor 26 calculates the distance between the ambient ozone generating device 10 and a wall, ceiling, or floor. In the illustrated embodiment, the system 10 is placed in approximate center of the structure and the assumption is made that the structure is square. Further, the assumption is made that the ceilings are disposed at a standard ceiling height such as eight feet above the floor. With these assumptions, the volume of the structure is estimated. It will be understood that measurements may be taken in more than one direction such that the volume within the structure is more accurately determined. Those skilled in the art will appreciate that the structure measuring device 28 can use a principle other than sonar, such as radar, to measure distance without departing from the scope or presence of the present invention. The ambient ozone control system 10 requires only a single mono-directional structure measuring device 28 to remain within the scope or spirit of the present invention.

After the processor 26 calculates the volume of the structure 36, the processing device 26 calculates the amount of ozone required to achieve the desired ozone concentration within the structure 36. In one embodiment, the processor 26 accesses a look-up table (LUT) which relates structure size to percentage capacity of ozone production for the particular system 10. Following is an exemplary LUT:

| STRUCTURE SIZE (sq. ft) | % OZONE PRODUCTION CAPACITY |
|---|---|
| 100 | 0 |
| 200 | 10% |
| 400 | 20% |
| 600 | 30% |
| 1,000 | 40% |
| 1,400 | 50% |
| 1,800 | 60% |
| 2,200 | 70% |
| 2,600 | 85% |
| 3,000 | 100% |

The processor 26 causes the ozone generating device 30 to generate the amount of ozone required to achieve the desired ozone concentration. Additionally, while the ozone generating device 30 is generating ozone, the processor 26 causes the fan 20 to circulate the generated ozone throughout the structure 36 such that the generated ozone within the structure 36 is substantially evenly distributed. If the structure size is larger than the minimum for the particular system 10, a user may activate the ozone concentration control 16 to raise or lower the ozone concentration level. In the above example, for a room having 1,000 sq. ft., the LUT indicates that the system 10 will default to 40% of its maximum ozone production. However, a user may increase or decrease that

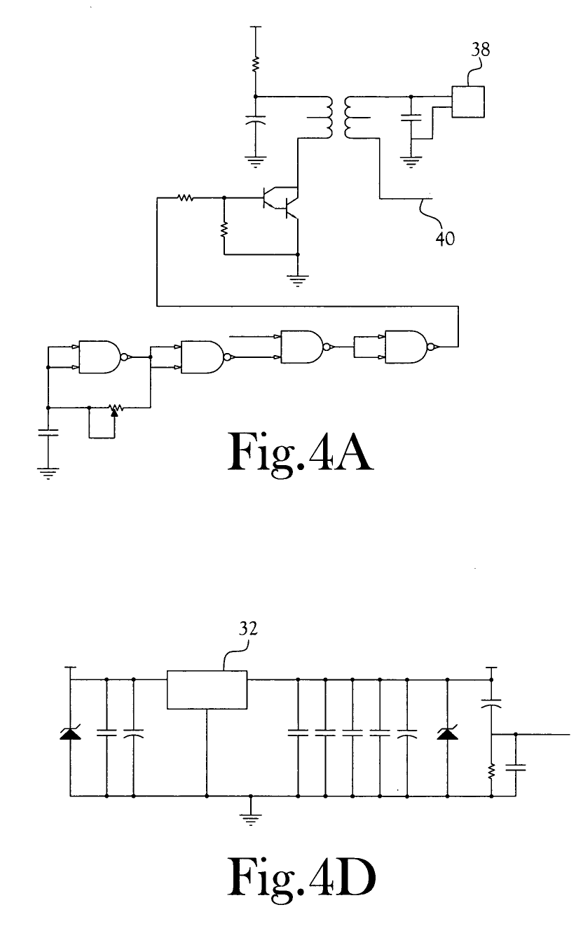

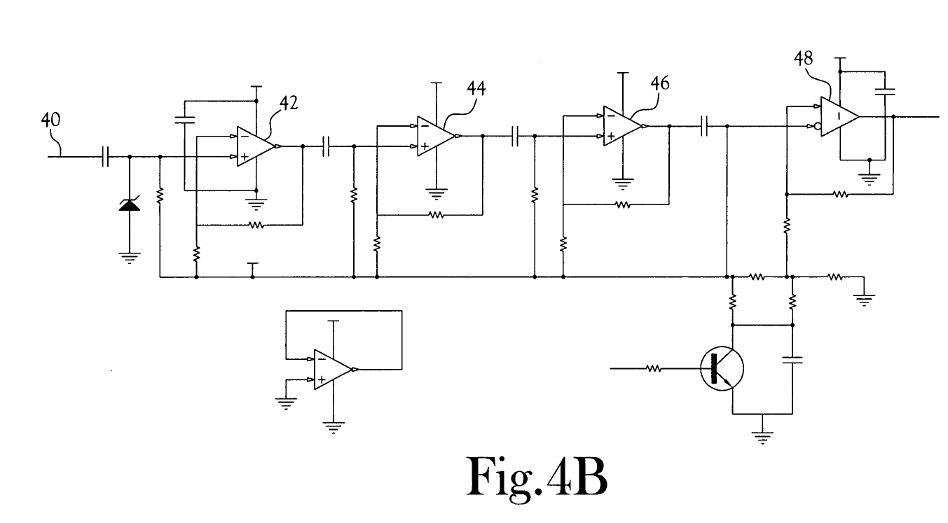

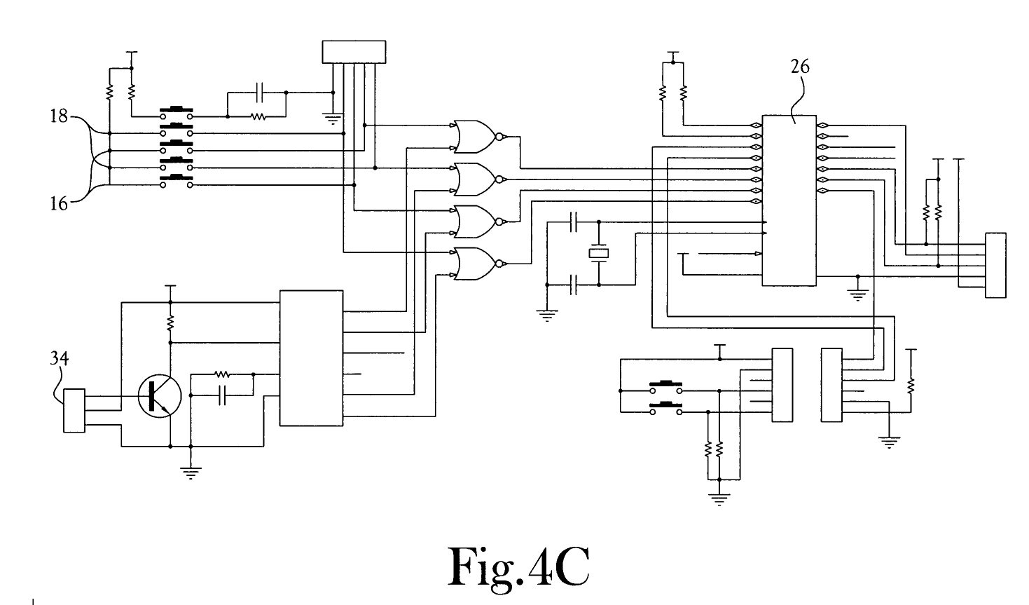

FIG. 4 illustrates an exemplary circuitry of the system 10. A power supply 32 is provided for powering the system 10. An infrared (IR) receiver 34 is provided for receiving control signals from the remote control 24. The ozone concentration control 16 and the fan control 18 are each provided for controlling the ozone concentration output and the fan.

In order to determine the volume within the structure 36, a signal is generated by a transducer 38 and a timer is activated. Time is counted until the signal is reflected back to and received by a receiver 40. The signal is then amplified via the amplifiers 42, 44, 46, 48 and input to the processor 26. The total time is calculated and, from this, the distance to the object on which the signal was reflected is determined.

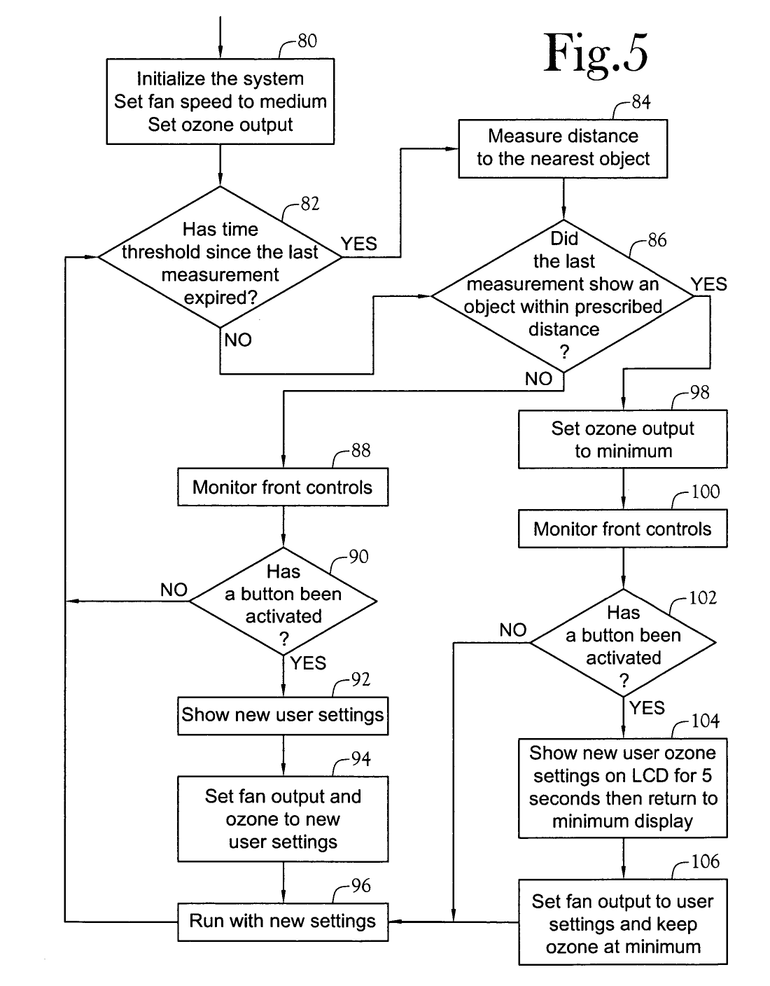

The operation of the system 10 is illustrated generally in FIG. 5. Illustrated at 80, the system 10 is initialized and the fan speed and desired output are set. At 82, a timer determines when 5 seconds has lapsed and sends an inquiry. If there has been no measurement within a threshold time, such as the illustrated 5 seconds, then the distance to the nearest object is measured at 84. The decision is then made at 86 as to whether the last measurement showed an object within a prescribed distance. If it did not, then the ozone concentration control 16 and the fan control 18 are monitored at 88 and a determination is made at 90 as to whether one of the controls 16, 18 has been actuated. If no, then the decision is again made at 82 as to whether the threshold time has elapsed. If yes, then the new user settings are displayed at 92, the fan output an ozone are set at 94, and the system is run at the new settings 96.

If an object was found within the prescribed distance at 86, then the ozone is set to a minimum value at 98 and the ozone concentration control 16 and the fan control 18 are monitored at 100. The decision is made at 102 as to whether one of the ozone concentration control 16 and the fan control 18 has been actuated. If not, the system 10 runs at new settings. If a button has been actuated, then the new settings are displayed at 104 for a period of time, then the display is returned to normal. The fan is then sat to output. However, the ozone is maintained at a minimum while the fan output is changed per user input.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. An ambient ozone control system for generating a desired ozone concentration within a substantially enclosed structure, said system comprising:
a structure measuring device for measuring at least one distance from said system to one surface of the enclosed structure;
a processor for estimating a volume within the enclosed structure using said at least one distance, said processor being further provided for determining an amount of ozone required to achieve a desired ozone concentration within the enclosed structure based on the volume; and
an ozone generating device for generating the required amount of ozone, said ozone generating device being in communication with said processor.

2. The system of claim 1 wherein said structure measuring device includes a transducer for sending and receiving a signal, said processor being further provided for determining a response time between a time when a signal is sent by said transponder and a time said signal is received by said transponder, said processor determining a distance from said system to the surface of the enclosed surface using said response time.

3. The system of claim 1 wherein said structure measuring device includes a plurality of transducers for sending and receiving a plurality of signals, said processor being further provided for determining a response time between a time when a signal is sent by each of said plurality of transponders and a time said signal is received by a respective one of said plurality of transponders, said processor determining a distance from said system to a respective surface of the enclosed surface using said response time.

4. In an improved ambient ozone control system for generating a desired ozone concentration within a substantially enclosed structure, said system including a processor and an ozone generating device for generating ozone, said ozone generating device being in communication with said processor, the improvement comprising:
a structure measuring device for measuring at least one distance from said system to one surface of the enclosed structure; and
wherein said processor is further provided for estimating a volume within the enclosed structure using said at least one distance, said processor being further provided for determining an amount of ozone required to achieve a desired ozone concentration within the enclosed structure based on the volume.

5. The system of claim 4 wherein said structure measuring device includes a transducer for sending and receiving a signal, said processor being further provided for determining a response time between a time when a signal is sent by said transponder and a time said signal is received by said transponder, said processor determining a distance from said system to the surface of the enclosed surface using said response time.

6. The system of claim 4 wherein said structure measuring device includes a plurality of transducers for sending and receiving a plurality of signals, said processor being further provided for determining a response time between a time when a signal is sent by each of said plurality of transponders and a time said signal is received by a respective one of said plurality of transponders, said processor determining a distance from said system to a respective surface of the enclosed surface using said response time.

7. A method for generating a prescribed ozone concentration within an enclosed structure, said method comprising the steps of:
a) placing an ambient ozone control system within the enclosed structure, the ambient ozone control system including a structure measuring device for measuring at least one distance from said system to one surface of the enclosed structure; a processor for estimating a volume within the enclosed structure using said at least one measured distance, said processor being further provided for determining an amount of ozone required to achieve a desired ozone concentration within the enclosed structure based on the volume; and an ozone generating device for generating the required amount of ozone, said ozone generating device being in communication with said processor;
b) acquiring a distance from said system to one surface of the enclosed structure using said structure measuring device;
c) determining a volume with the enclosed structure using said processor;
d) determining a required volume of ozone to achieve the prescribed ozone concentration using said determined enclosed structure volume; and
e) operating said ozone generating device to generate said required volume of ozone.

8. The method of claim 7, wherein said step of d) determining a required volume of ozone includes the step of accessing a look-up table (LUT), said LUT relating structure size to percentage capacity of ozone production of said ambient ozone control system.

9. The method of claim 8, after said step of d) determining a required volume of ozone, further comprising the step of adjusting said required volume of ozone, said step of adjusting said required volume of ozone being performed manually by actuating one of a manual control carried by said system and a remote control in communication with said system.

10. The method of claim 7, after said step of e) operating said ozone generating device, further includes the step of f) repeating periodically said steps of b) acquiring a distance through e) operating said ozone generating device, whereby said desired ozone concentration within the structure is maintained.
